(19) United States
(12) Patent Application Publication
(10) Pub. No.: US 2025/0216235 A1
(43) Pub. Date: Jul. 3, 2025

(54) SENSOR ARRANGEMENT

(71) Applicant: Hahn-Schickard-Gesellschaft für angewandte Forschung e.V., Villingen-Schwenningen (DE)

(72) Inventors: Philipp RAIMANN, Villingen-Schwenningen (DE); Sophie BILLAT, Villingen-Schwenningen (DE); Frank HEDRICH, Villingen-Schwenningen (DE)

(73) Assignee: Hahn-Schickard-Gesellschaft für angewandte Forschung e.V., Villingen-Schwenningen (DE)

(21) Appl. No.: 19/084,787

(22) Filed: Mar. 20, 2025

Related U.S. Application Data
(63) Continuation of application No. PCT/EP2023/075799, filed on Sep. 19, 2023.

(30) Foreign Application Priority Data
Sep. 20, 2022 (DE) 102022209906.0

(51) Int. Cl. G01F 1/684; G01L 11/00

(52) U.S. Cl. CPC G01F 1/6845; G01L 11/002

(57) ABSTRACT

A sensor arrangement having: a first sensor cell which can be excited thermally by means of a heater; a second sensor cell which can be excited thermally by means of a heater; and an evaluation; wherein the first and second sensor cells are sensor cells of the same kind and are dimensioned and/or configured differently, and are configured to form a respective oscillation behavior in dependence on a gas property of a gas surrounding the sensor cells, in particular heat conductivity, volume heat capacity, temperature and/or pressure, and the evaluation is configured to evaluate the oscillation behavior of the first and second sensor cells together in order to determine the heat conductivity and volume heat capacity, heat conductivity being determined based on the oscillation behavior of the first sensor cell and volume heat capacity being determined based on the oscillation behavior of the second sensor cell.

### CROSS-REFERENCE TO RELATED APPLICATIONS

This application is a continuation of International Application No. PCT/EP2023/075799, filed Sep. 19, 2023, which is incorporated herein by reference in its entirety, and additionally claims priority from German Application No. 102022209906.0, filed Sep. 20, 2022, which is also incorporated herein by reference in its entirety.

### TECHNICAL FIELD

Embodiments of the present invention relate to a sensor arrangement and to a corresponding evaluation method. Further embodiments relate to a flow sensor having a corresponding sensor arrangement and/or to a pressure sensor having a corresponding sensor arrangement.

### BACKGROUND OF THE INVENTION

The output signals of thermal flow sensors (in general flow sensors) are not only influenced by the flow rate (l/min) but also by gas properties, like density ρ, heat conductivity k and/or specific heat capacity c of the flowing medium, for example. The gas properties in turn are dependent on temperature and pressure. If, for example, the gas composition, temperature and/or pressure change with a constant flow rate, the output signal will also change, which may erroneously be interpreted as a change in the flow rate. Thus, thermal flow sensors are either calibrated for a gas/gas mixture or the gas properties have to be determined by further additional sensors in order to compensate the resulting output signal using algorithms. Signal compensation is more precise when the sensors are located in direct proximity to the flow sensor.

Consequently, the conventional technology is calibrating flow sensors to gas properties (known pressure, temperature and gas composition) or allowing signal compensation by additional independent MEMS sensors (like environmental sensors). In accordance with the conventional technology, sensors having different measuring principles have to be integrated. In typical sensor arrangements of low complexity, heat conductivity and volume heat capacity cannot be determined easily so as to allow calibration. Therefore, there is need for an improved approach.

Embodiments of the present invention are based on the object of providing a concept which allows determining volume heat capacity and heat conductivity in a reliable and precise manner using a measuring arrangement of low complexity.

### SUMMARY

According to an embodiment, a sensor arrangement may have: a first sensor cell which can be excited thermally by means of a first heater; a second sensor cell which can be excited thermally by means of a second heater; and an evaluation; wherein the first sensor cell and the second sensor cell are sensor cells of the same kind and wherein the first sensor cell and the second sensor cell are dimensioned and/or configured differently; wherein the first sensor cell and the second sensor cell are configured to form a respective oscillation behavior, in particular oscillation behavior of the respective first or second heater, in dependence on a gas property of a gas surrounding the first and second sensor cell, in particular heat conductivity and/or volume heat capacity and/or temperature and/or pressure, wherein the evaluation is configured to evaluate the respective oscillation behavior of the first sensor cell and the second sensor cell together in order to determine the heat conductivity and volume heat capacity, wherein the heat conductivity is determined based on the oscillation behavior of the first sensor cell and wherein the volume heat capacity is determined based on the oscillation behavior of the second sensor cell.

According to another embodiment, a sensor arrangement may have: a first sensor cell which can be excited thermally by means of a first heater; and a second sensor cell which can be excited thermally by means of a second heater; wherein the first sensor cell and the second sensor cell are sensors of the same kind and wherein the first sensor cell and the second sensor cell are dimensioned and/or configured differently; wherein the first sensor cell and the second sensor cell are configured to change a respective oscillation behavior in dependence on a gas property of a gas surrounding the first and second sensor cells, in particular heat conductivity and/or volume heat capacity and/or temperature and/or pressure, wherein the respective oscillation behavior of the first sensor cell and the second sensor cell can be evaluated together in order to determine the heat conductivity and volume heat capacity, wherein the heat conductivity is determined based on the oscillation behavior of the first sensor cell, and wherein the volume heat capacity is determined based on the oscillation behavior of the second sensor cell.

Another embodiment may have a flow sensor having any of the inventive sensor arrangements as mentioned above, wherein the flow sensor is configured to determine a flow while considering the heat conductivity and volume heat capacity determined.

Another embodiment may have a pressure sensor having any of the inventive sensor arrangements as mentioned above, wherein the pressure sensor is configured to determine the pressure while considering the volume heat capacity and the heat conductivity.

According to another embodiment, a method for evaluating any of the inventive sensor arrangements as mentioned above may have the step of: evaluating a respective oscillation behavior of the first and second sensor cells together in order to determine the heat conductivity and volume heat capacity (or determine physical parameters of a first group and physical parameters of a second group), wherein the heat conductivity is determined based on the oscillation behavior of the first sensor cell, and wherein the volume heat capacity is determined based on the oscillation behavior of the second sensor cell.

Another embodiment may have a non-transitory digital storage medium having stored thereon a computer program for performing the above inventive method when the computer program is run by a computer or the evaluation.

Embodiments of the present invention provide a sensor arrangement comprising a first sensor cell and a second sensor cell, and an evaluation device. The first sensor cell can be excited thermally by means of a heater or comprises a heater for thermal excitation. The second sensor cell can also be excited thermally by means of a (separate) heater or comprises a (separate) heater for thermal excitation. The first and second sensor cells are sensor cells of the same kind which, however, are dimensioned or implemented differently. The first and second sensor cells are configured to form a respective oscillation behavior, in particular a (thermal) oscillation behavior of the heater, in dependence on a gas property of a gas surrounding the first and second sensor cells, in particular heat conductivity or volume heat capacity or temperature or pressure. The evaluation is configured to evaluate the respective oscillation behavior of the first sensor cell and the second sensor cell together to determine the heat conductivity and volume heat capacity (or to determine physical parameters of a first group (which heat conductivity belongs to) and physical parameters of a second group (which volume heat capacity belongs to)). In accordance with embodiments, the oscillation behavior can be detected by means of one detector per sensor cell. The evaluation determines the heat conductivity based on the oscillation behavior of the first sensor cell, wherein volume heat capacity is determined based on the oscillation behavior of the second sensor cell.

Embodiments of the present invention are based on the finding that, by using two differently dimensioned or at least two differently configured sensors, it is possible to use the two sensors for detecting different physical parameters belonging to different groups, that is for group 1 heat conductivity and for group 2 volume heat capacity. Due to the different dimensioning, differently high sensitivities for the different physical parameters are formed in association to the different groups. Different sensitivities over the frequency range or sensor geometry allow volume heat capacity cᵥ and heat conductivity k to be determined independently. Consequently, in the sensor arrangement, several thermal sensors are used which can be excited and read out either equally or independently of one another. At least one sensor is (operated in a frequency range and/or) dimensioned such that it exhibits high sensitivity to heat conductivity k and at the same time low cross sensitivity to volume heat capacity cᵥ. At least one more sensor is (operated in a frequency range and/or) dimensioned such that it exhibits high sensitivity to volume heat capacity cᵥ and at the same time low cross sensitivity to heat conductivity k. Two operating modes result from this, that is different dimensioning+different frequencies and different dimensioning+equal frequencies.

Sensor cell: In accordance with embodiments, the first sensor cell and/or the second sensor cell comprise a cavity having a heater or spaced-apart heater. The cavity or bottom of the cavity forms a heat sink. Consequently, the setup can be drafted generally as a heat sink having a spaced-apart heater or also a heat sink having a heating rib spaced apart from the heat sink. In accordance with embodiments, the heater is formed by a heating rib or a self-supporting structure or self-supporting bridge structure. In accordance with embodiments, the heater or heating rib or the self-supporting structure/bridge structure is configured to oscillate thermally and thus correspondingly implement the oscillation behavior. This means that, in accordance with embodiments, the oscillation behavior of the first and second sensor cell each is formed in particular by the heater/heating rib/self-supporting structure. In accordance with further embodiments, the first and/or second sensor cell may comprise a detector configured to detect the oscillation behavior.

Detector: In accordance with embodiments, the evaluation is configured to determine the oscillation behavior of the first and second sensor cells using the dynamic temperature response, in particular using the amplitude and/or using the frequency and/or using the phase. In accordance with further embodiments, a model can be used which describes excitation at a cutoff frequency to be proportionate to the temperature conductivity of the gas, wherein the temperature conductivity is defined to be a division of heat conductivity divided by volume heat capacity.

In the above embodiments, it has been assumed that the first and second sensor cells are dimensioned differently. Different dimensioning is present if the first and/or second sensor cells differ relative to one or more parameters from the following group of:
volume of the sensor,
width of the membrane,
thickness of the membrane,
area of the membrane,
width of the cavity,
height of the cavity,
area of the cavity,
volume of the cavity,
length of the heater,
thickness of the heater,
geometry of the heater,
material of the membrane.

In accordance with embodiments, the consequence of different dimensioning or implementation is that the first and/or second sensor cells are configured for respective different cutoff frequencies which differ at least by a factor of 3 or even at least a factor of 5 or, advantageously, even at least by a factor of 10. In accordance with embodiments, the consequence of this is that the sensitivities of the second sensor cell to volume heat capacity is higher by at least a factor of 3, at least a factor of 4 or at least a factor of 5 than the sensitivity of the first sensor cell to volume heat capacity. Inversely, the result is that the sensitivity of the first sensor cell to heat conductivity is higher by at least a factor of 1.1 or at least a factor of 1.2 than the sensitivity of the second sensor cell to heat conductivity. Preferably, this means that, by means of the differently dimensioned sensors or differently configured sensors, the physical parameters in association to different groups (heat conductivity or heat capacity) can be determined independently of one another.

In accordance with embodiments, the evaluation is configured to excite the first and/or second sensor cell to oscillate, for example periodically. Here, an equal frequency can be used for the two sensor cells. The two sensor cells can be excited by the same frequency at the same time. In accordance with an alternative variation, different frequencies may be used (at the same time). For example, excitation may take place by means of an excitation frequency, wherein the excitation frequency or the evaluation frequency for the first sensor cell may be below the cutoff frequency, for example below ½ of the cutoff frequency or below ¼ of the cutoff frequency, for example. Alternatively or additionally, the second sensor cell can be excited by an excitation frequency, wherein the excitation frequency or evaluation frequency of the second sensor cell is above a cutoff frequency, for example three times the cutoff frequency.

Dimensioning/configuration: In accordance with embodiments, two different approaches can be differentiated between:
minimum approach: Sensitivity is sufficiently different
radical approach: Sensor is maximally insensitive, but the other one to a maximum.

The respective principle is selected via sensor dimensioning and/or the operating point.

Implementation: With regard to the setup, it is to be pointed out again that, in accordance with embodiments, the first and/or second sensor cells are advantageously arranged on a common chip, that is integrated monolithically on a chip. Evaluation may be integrated in the same chip. In accordance with embodiments, the evaluation may be implemented as an ASIC which is connected to the chip or set up monolithically in a common chip (which accommodates the first and second sensor cells). In accordance with further embodiments, the sensor arrangement may also be used without evaluation. Here, the sensor arrangement comprises a first sensor cell and a second sensor cell which may each be excited thermally by means of a heater. Here, the respective oscillation behavior of the first sensor cell and the second sensor cell can be evaluated together in order to determine heat conductivity and volume heat capacity, wherein the heat conductivity is determined based on the oscillation behavior of the first sensor cell and volume heat capacity is determined based on the oscillation behavior of the second sensor cell.

Preferably, the sensor arrangement can be used in a flow sensor, wherein the flow sensor is configured to determine a flow while considering the heat conductivity and volume heat capacity determined. A further application, in accordance with embodiments, relates to a pressure sensor configured to determine pressure while considering volume heat capacity and heat conductivity. For these two sensors, it is therefore of advantage since, as mentioned above, the volume flow or flow measured or pressure measured is highly dependent on the gas properties so that, when knowing the physical parameter(s) of heat conductivity and volume heat capacity, calibration may take place or evaluation may take place correspondingly.

A further embodiment relates to a method for evaluating a sensor arrangement having the central step of evaluating a respective oscillation behavior of the first and second sensors together in order to determine heat conductivity and volume heat capacity (or to determine physical parameters of a first group and physical parameters of a second group), wherein the heat conductivity is determined based on the oscillation behavior of the first sensor and wherein the volume heat capacity is determined based on the oscillation behavior of the second sensor.

In accordance with further embodiments, the method may be computer-implemented.

### BRIEF DESCRIPTION OF THE DRAWINGS

Before discussing embodiments of the present invention below referring to the appended drawings, it is pointed out that elements and structures of equal effect are provided with equal reference numerals so that the description thereof is mutually applicable or interchangeable.

FIGS. 1a and 1b schematically show, in a sectional view (FIG. 1a) and top view (FIG. 1b), a sensor cell for being used in embodiments;

FIGS. 2a-2q show schematic illustrations of sensor cells for being used in extended embodiments;

FIGS. 3a and 3b show a schematic embodiment of a sensor arrangement comprising two sensor cells in accordance with a main embodiment;

FIGS. 3c and 3d show schematic diagrams for illustrating potential sensor cells dimensions in accordance with embodiments;

FIGS. 4a and 4b show schematic diagrams for discussing the sensitivity to heat conductivity and volume heat capacity for two sensor cells in accordance with embodiments;

FIG. 5 shows a schematic block circuit diagram of sensor cell comprising evaluation electronics in accordance with a comparison aspect;

FIGS. 6a and 6b show schematic diagrams for illustrating the comparison aspect from FIG. 5;

FIGS. 7a and 7b show schematic diagrams for illustrating sensitivities plotted over frequency for discussing potential configurations in accordance with embodiments;

FIG. 8 shows a schematic diagram for illustrating the dependence between sensor sensitivity and measuring gas; and

FIGS. 9a, 9b, 9c and 9d show schematic illustrations of potential applications in accordance with embodiments.

### DETAILED DESCRIPTION OF THE INVENTION

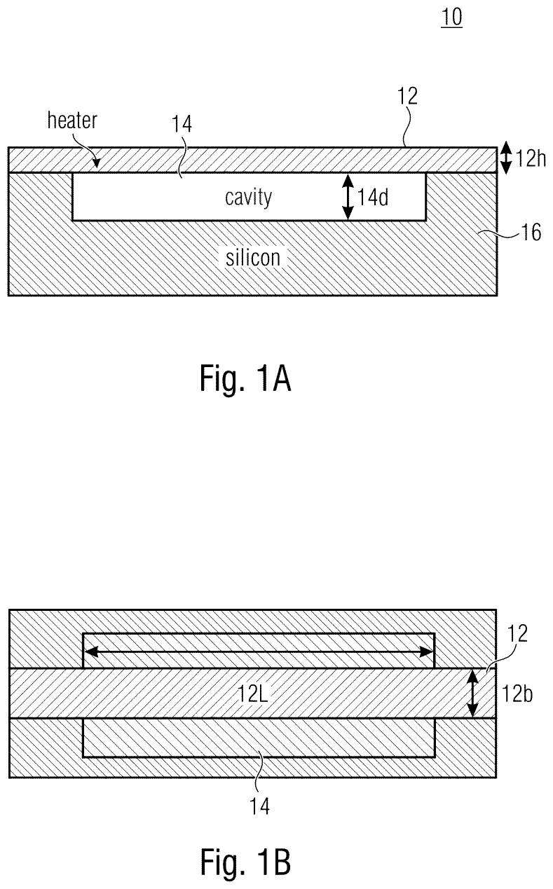

FIG. 1a shows a sectional view of a sensor cell 10 and FIG. 1b a top view. The sensor cell 10 comprises a heater 12 which is arranged, for example, as a self-supporting structure above a cavity 14. The cavity 14 may, for example, be embedded in a silicon substrate 16. The heater 14 can be excited to oscillate thermally by excitation by means of a drive frequency. Here, an alternating voltage or current having the corresponding frequency flows through the same, for example. Starting from the excitation, the result is a frequency-dependent temperature superelevation or, if applicable, low-pass behavior. This temperature superelevation or low-pass behavior is dependent on geometry parameters and material properties. Essential geometry parameters are, for example, the height of the heater 12h, the width of the heater 12b, and the length of the heater 12l. A further parameter is the volume of the cavity 14 which basically is dependent on the height of the cavity 14d. The silicon substrate 16 or the lower side of the cavity 14 serves as a temperature sink for the heater 12, wherein heat transfer in the temperature sink depends on the thickness 14d of the cavity 14.

A sensor cell 10 excited to oscillate in this way is configured to oscillate at a corresponding frequency. This frequency is dependent on physical parameters of the surrounding gas, both on the side of the cavity 14 and on the side opposite the cavity 14, which serves as the measuring side, for example. Influential factors are temperature, pressure, but in particular heat conductivity and volume heat capacity, for example. Conversely, this allows these physical parameters of heat conductivity and/or volume heat capacity to be determined starting from the oscillation behavior of the heater. Here, the oscillation behavior is monitored by means of a detector (not illustrated), for example.

The determination method is as follows:
Heater is excited periodically (current or voltage) and heats up (Joule heating).
Temperature of the heater varies and is dependent on the heat exchange with the surrounding gas (the gas to be analyzed/surrounding the self-supporting heat structure 12).
Heat conductivity and volume heat capacity influence dynamic heat dissipation to the gas.
As a consequence, the dynamic temperature response of the heater 12 (amplitude and phase, for example) can be measured and resistive or thermos-electric monitoring of the thermal response may take place for detection. The following heat transfer temperature T results, for example. T=function (L, h, b, d, kₕ, cvₕ, k_{gas}, cv_{gas}) with the following surrogate parameters: Rₕₑₐₜₑᵣ=L/(h*b*kₕ); Cₕₑₐₜₑᵣ=cvₕ*b*h*L; R_{gas}=d/(L*b*k_{gas}); C_{gas}=d*b*L*cv_{gas}.

If gasses exhibit different k_{gas} and cv_{gas}, the amplitude and the dynamic behavior differ with frequency. The system exhibits a high-pass behavior, that is the temperature decreases with an increasing frequency and phase shift increases with an increasing frequency. This frequency-dependent behavior may, apart from sensor dimensioning, also be dependent on the gas properties. If an equilibrium between the scaling factors for width of heater b and width of effective heat transfer area to the gas b_{gas} is assumed, the cutoff frequency is described by the following relation. The scaling factors can be eliminated for b_{gas}=b and the following applies:

$${f}_{cutoff} = \frac{h \cdot {k}_{h}}{2 \cdot π \cdot {L}^{2} ( {cv}_{h} \cdot h + {cv}_{gas} \cdot d )} + \frac{{k}_{gas}}{2 \cdot π \cdot d ( {cv}_{h} \cdot h + {cv}_{gas} \cdot d )}$$

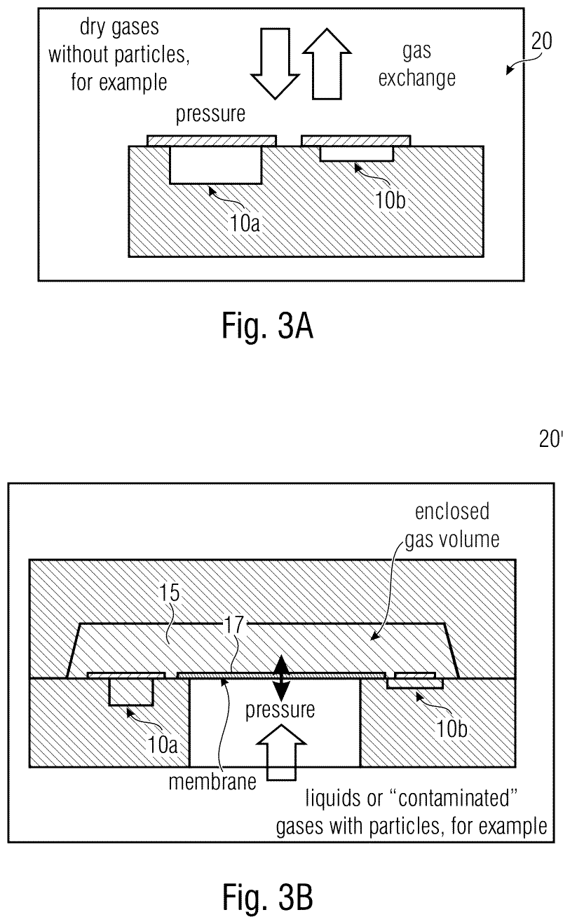

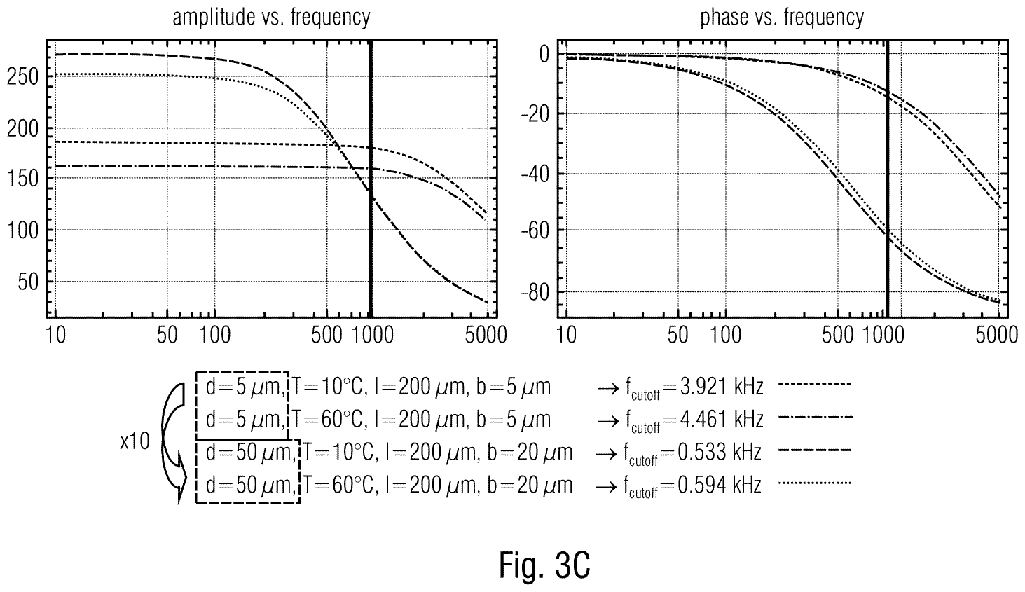

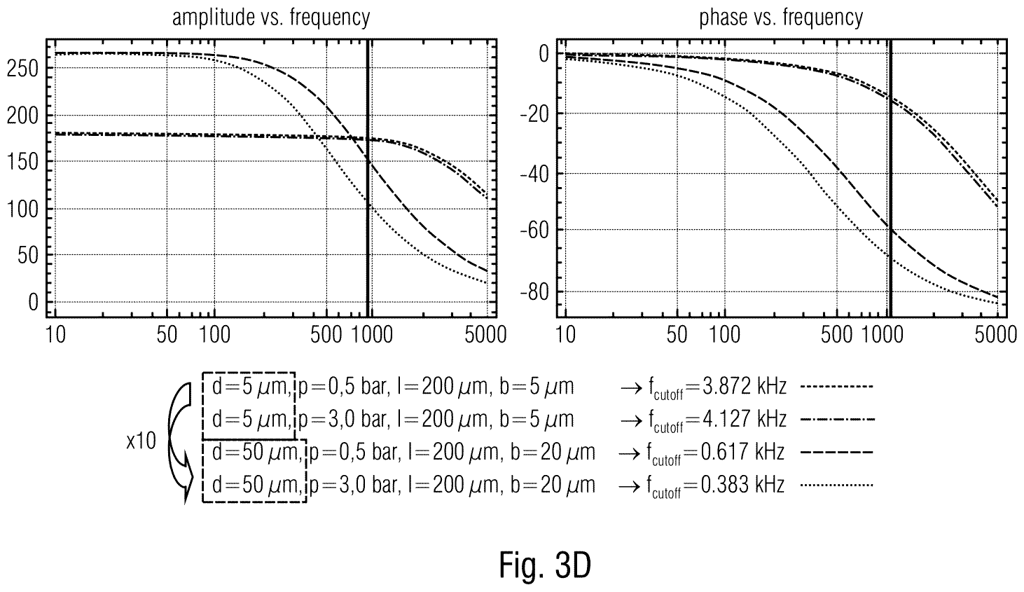

It can be derived from this that the cutoff frequency will be the smaller, the lower heat conductivity and the higher volume heat capacity. This means that an increase in pressure decreases the cutoff frequency of the system. An increase in temperature increases the cutoff frequency of the system. This background, from a physical point of view, results in the finding of the invention that, by using two sensor cells of different dimensioning (maybe with different drive frequency), as are shown, for example, in FIG. 3a or 3b, the heat conductivity k_{gas} or sₖ and the volume heat capacity s_{cv} or cv_{gas} can be determined independently of each other. Here, a sensor having a high sensitivity to heat conductivity is used in combination with a sensor of high sensitivity to volume heat capacity, for example. FIG. 3a shows a sensor arrangement 20 comprising a first sensor 10a and a second sensor 10b. As can be recognized, the sensors are dimensioned to be of different sizes, wherein the basic principle corresponding to that from FIG. 1a and FIG. 1b. Both sensor cells 10a and 10b are facing a gas to be examined with their side facing away from the cavity or are embedded in a device such that gas exchange, for example, with dry gasses without particles, may take place.

Potential variation parameters for the different dimensioning of the (two) sensor cells are, for example:
Geometrical parameters (length, width, layer thickness)
A heater may be formed from several heaters (two heaters in parallel, combination of several types of heaters, for example)
Types of heaters (holes, for example, honey comb structure, with membrane, meandering, . . . )
Materials/material combinations (thermal characteristics, passivation, . . . ) FIG. 3 shows a slightly varied setup in which the sensors 10a and 10b in the sensor arrangement 20′ are coupled indirectly via an enclosed volume. The enclosed volume is provided with the reference numeral 15 and encapsulated relative to the environment by a membrane 17. The gas to be measured or the medium to be measured, liquid or contaminated gas with particles acts on the membrane 17.

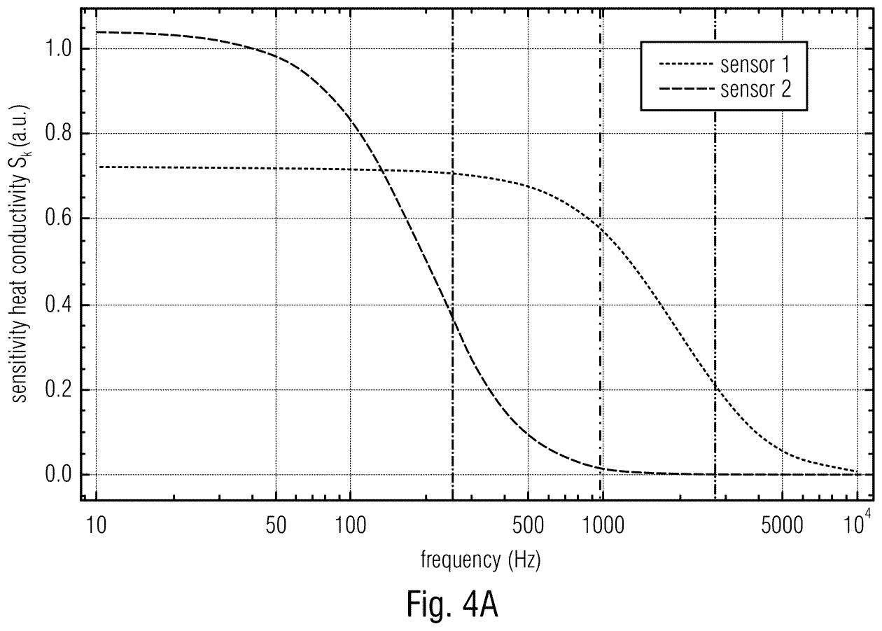

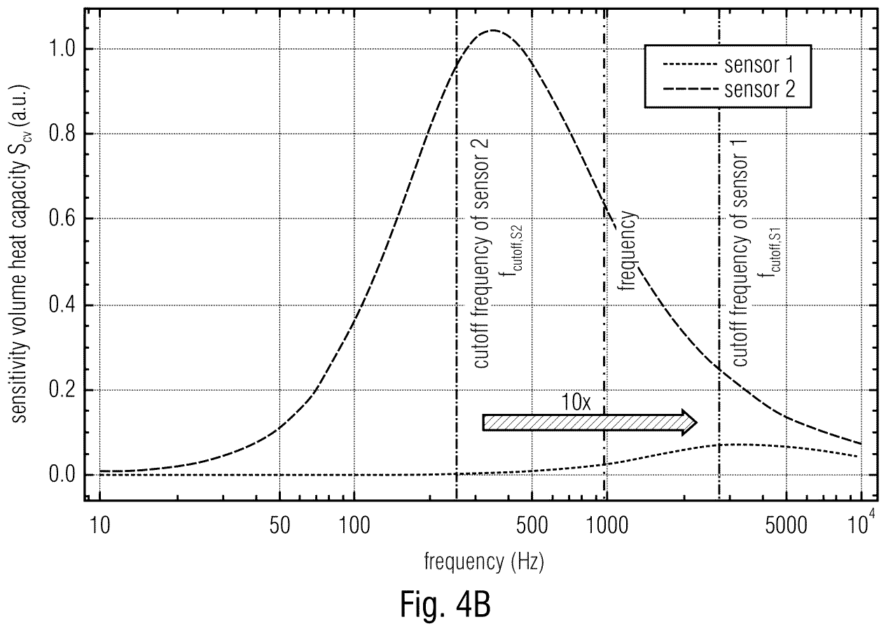

As can be recognized clearly, both in the implementation of FIG. 3a and the implementation of FIG. 3b, the dimensioning of the sensor cells 10a and 10b is different. This means that different sensitivities relative to the quantities to be measured of volume heat capacity cv and heat conductivity k result. This principle can be seen clearly when looking at FIGS. 4a and 4b, for example. FIG. 4a shows the sensitivity to heat conductivity Sₖ plotted over frequency for two different sensors, whereas FIG. 4b shows the sensitivity to volume heat capacity Sₑᵥ, again plotted over frequency, for the same two sensors. It can be seen that sensor 2, in particular in a frequency range of 10-100 Hz, is more sensitive than sensor 1, wherein sensor 1 exhibits an improved sensitivity over the entire frequency range or at least up to 1000 Hz. The difference between the sensitivities between sensor 1 and sensor 2 is not significant in these examples so that the operating point of sensor 1 and sensor 2 is important here. If, for example, the operating point is selected to be 350 Hz, sensor 1 is to be of advantage as to sensitivity of heat conductivity. It is to be pointed out here that the discussion of the operating points is only exemplarily and varies from one sensor to the next. In the diagram of FIG. 4b, the sensitivity to volume heat capacity S_{cv} is plotted for the two sensors 1 and 2. As can be seen, a significantly higher sensitivity is present in sensor 2 when compared to sensor 1. Here, the operating point would be selected in the range between 350 and 1000 Hz and sensor 2 be operated at the cutoff frequency f_{cutoff,S2}. In this range, sensor 1 advantageously exhibits good sensitivity to heat conductivity so that, when operating the two sensors with equal excitation or evaluation frequency, volume heat capacity and heat conductivity can be determined independently of each other using the two different sensors.

In accordance with a further embodiment, the operating point may vary per sensor. Preferably, sensor 2, for determining heat conductivity, would be operated below its cutoff frequency f_{cutoff,S2}, for example, at ⅓ thereof, to determine heat conductivity. Sensor 2 would be operated in the range of the cutoff frequency or a little higher than cutoff frequency f_{cutoff,S2}, in order to determine the volume heat capacity.

The result are different operating modes corresponding to different embodiments:
Different dimensioning+different frequencies
Different dimensioning+equal frequencies

When talking about frequency in the above embodiments, excitation frequency or evaluation frequency can be assumed. For example, the sensor can be excited at a certain frequency and be evaluated at another one. This is of advantage when using a Chirp signal or a Dirac signal, for example, and different frequencies are gone through. Alternatively, fixed excitation frequencies could be used for both sensors or for the respective sensors 10a and 10b.

It is common to the above embodiments that two thermal sensors or at least two thermal sensors are excited and read out independently of each other so that the different sensitivities of the two sensors which are either operated differently or are implemented differently, can be made use of. The sensitivities can be calculated as follows:

$${S}_{k} = \frac{\partial T ( {k}_{gas} , {cv}_{gas} , b , L , h , d , {k}_{h} , {cv}_{h} )}{\partial {k}_{gas}}$$

$${S}_{cv} = \frac{\partial T ( {k}_{gas} , {cv}_{gas} , b , L , h , d , {k}_{h} , {cv}_{h} )}{\partial {c}_{vgas}}$$

As has been mentioned above, the sensitivities can be adjusted via the operating point.

In accordance with embodiments, the excitation frequency for determining heat conductivity can be below the cutoff frequency, for example smaller than ¼ or smaller than ½. In accordance with further embodiments, the excitation frequency for determining the volume heat capacity can be above the cutoff frequency, for example be higher by a factor of 3 to 20 or, generally, larger by the factor of 2 or 3. In these ranges, the sensitivities Sₖ and S_{cv} differ in quantity.

In accordance with embodiments, irrespective of the dimensioning of the structures, it applies that high a sensitivity to heat conductivity can be obtained at low frequencies. The frequency can, in accordance with embodiments, also be f=0, which corresponds to DC operation. This means that the excitation frequency is in a range of f≥0, i. e. close to zero, for example. In accordance with embodiments, the excitation frequencies differ, that is are different in magnitude. In accordance with embodiments, with high frequencies, the structure can be insensitive to heat conductivity (sₖ approaching 0). In accordance with further embodiments, the sensitivity to volume heat capacity may exhibit a local maximum.

$$\partial {S}_{cv} / \partial cv = 0$$

It is known from literature that a specific optimization (both of geometry and frequency) is not possible based on the parameter model. The consequence is that a suitable optimum for the operating point of the sensor arrangement is looked for.

It is common to all the embodiments mentioned above that at least two sensors/sensor cells with different dimensioning, for example differing by at least one order of magnitude, are combined. These may, for example, be integrated on a silicon chip (that is monolithically) and thus form a different dynamic behavior with the propagation of heat in gases. Different dimensions/dimensioning of the sensors provide the basis for allowing that gas properties can be determined by determining the amplitude and/or the phase position of the heater with dynamic excitation.

Typical dimensions will be indicated below for an exemplary example. Here, all the dimensions may occur in combination or individually:
Length of the heater: 10-1000 μm
Width of the heater: 1-200 μm
Width of heat transfer: 1-500 μm
Height of the heater: 0.1-2 μm
Height of the cavity: 0.05-500 μm

With these dimensions, sensor cells of different dimensioning and, consequently, different oscillation behavior can be manufactured. The oscillation behavior is expressed in particular using the cutoff frequency f_{cutoff}. In FIG. 3c, four different sensors with different cutoff frequencies and thus with different oscillation behaviour are listed and illustrated in corresponding diagrams (amplitude vs. phase and phase vs. frequency). As can be recognized, by varying the cavity height d, a significant shift in the cutoff frequency by a factor of, for example, 10 can be achieved. This sensor is configured for a constant pressure of, for example, 1 bar and varying temperatures in a range from 10 to 60° C. Even with a constant temperature (like 24° C., for example) and varying pressure in the range from 0.5 to 3.0 bar, the result is similar, as can be recognized in FIG. 3d. Here, too, four sensors are illustrated, wherein it can again be recognized that the cavity height (in general height of the heating element above the heat sink) has a significant influence on the cutoff frequency f_{cutoff}.

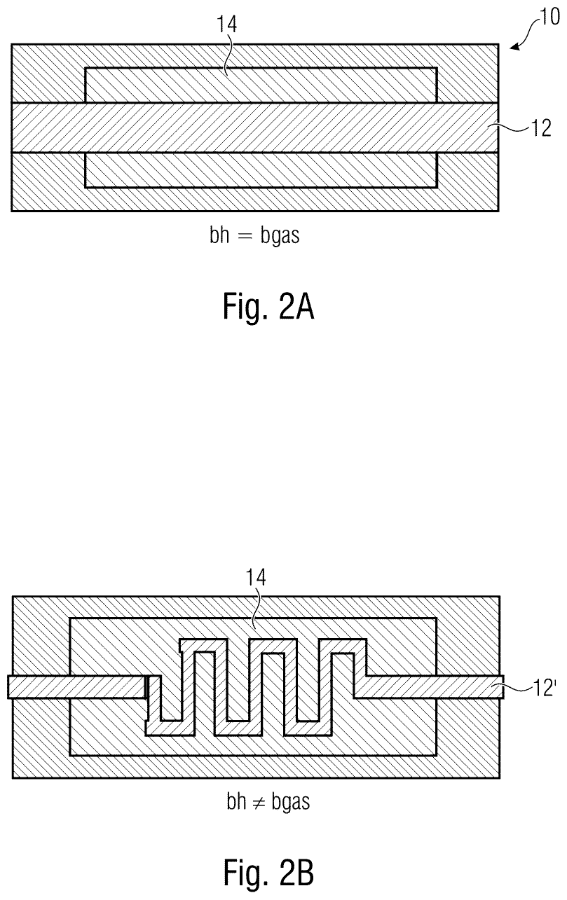

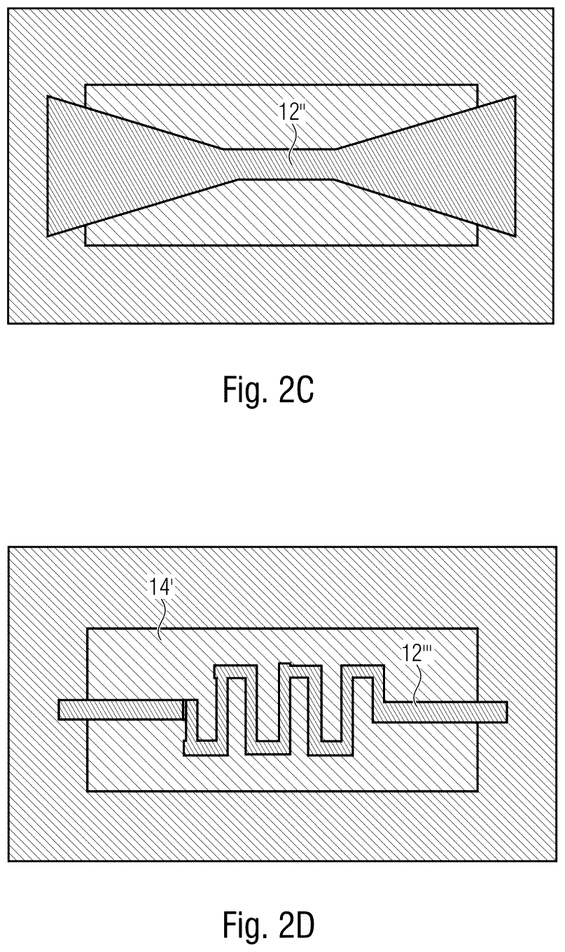

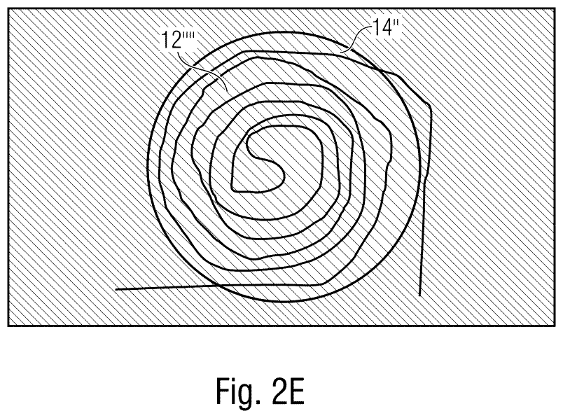

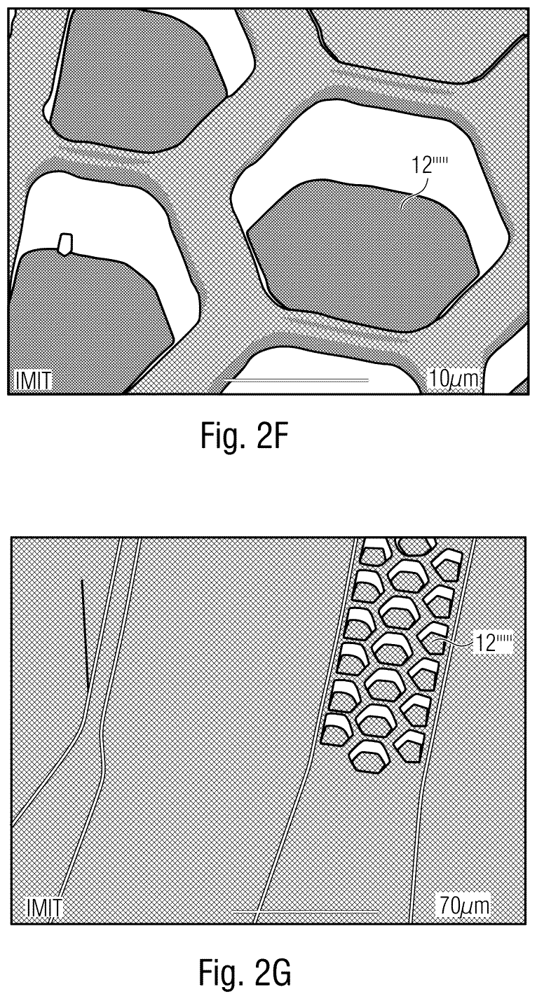

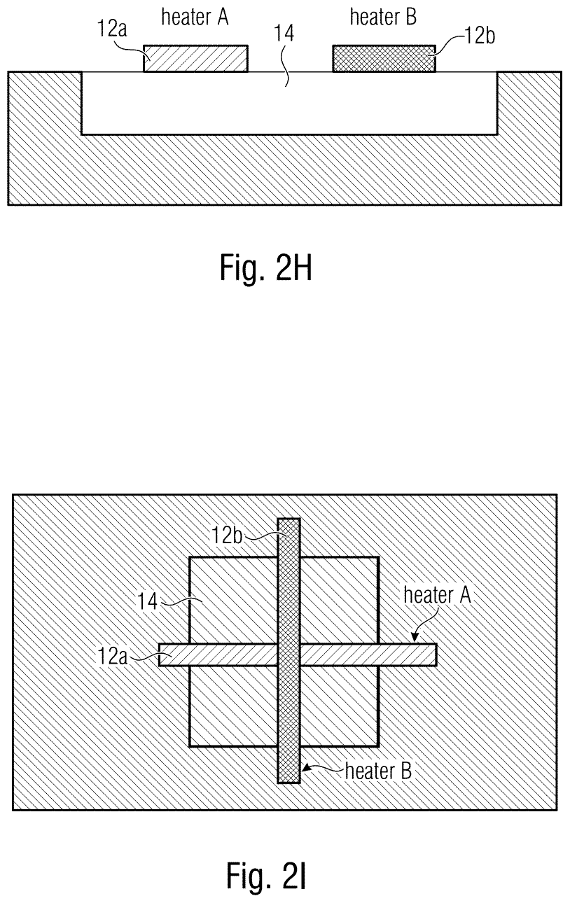

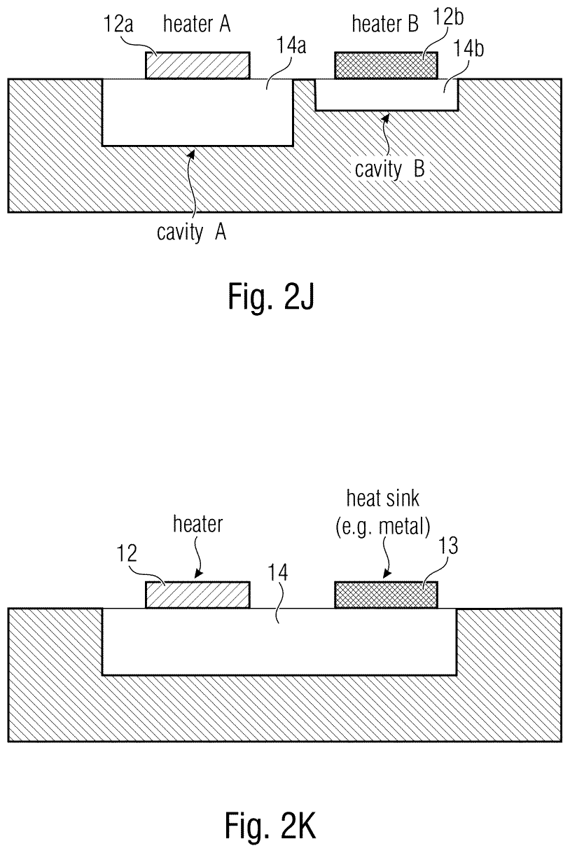

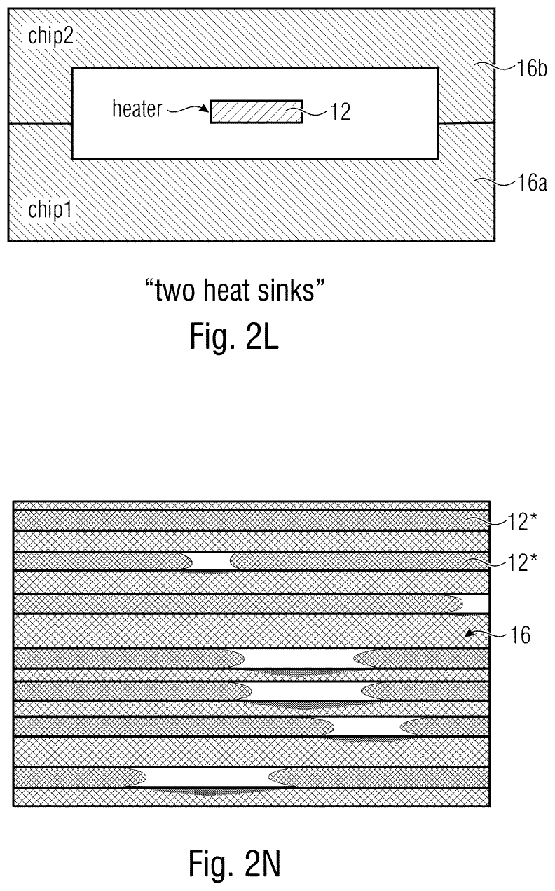

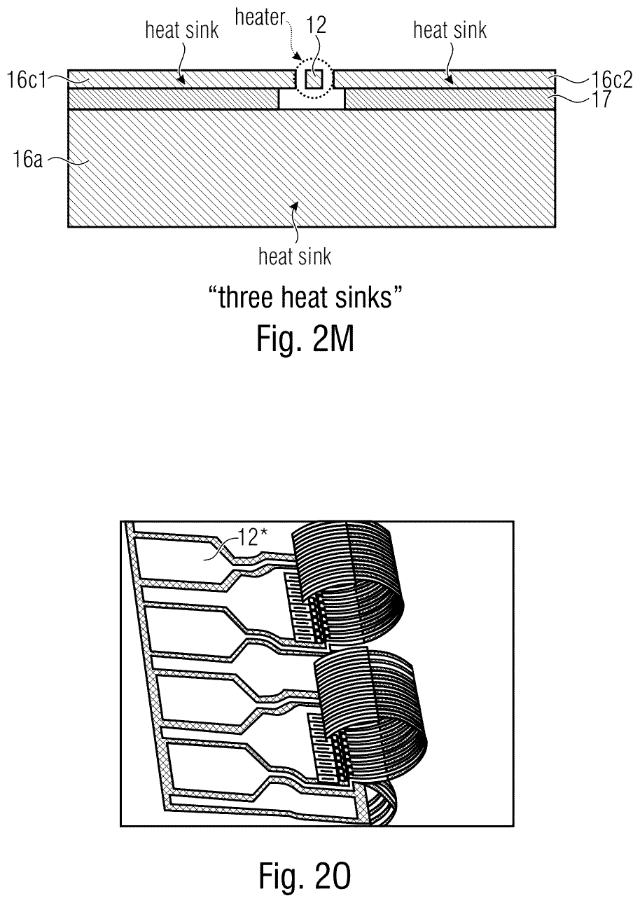

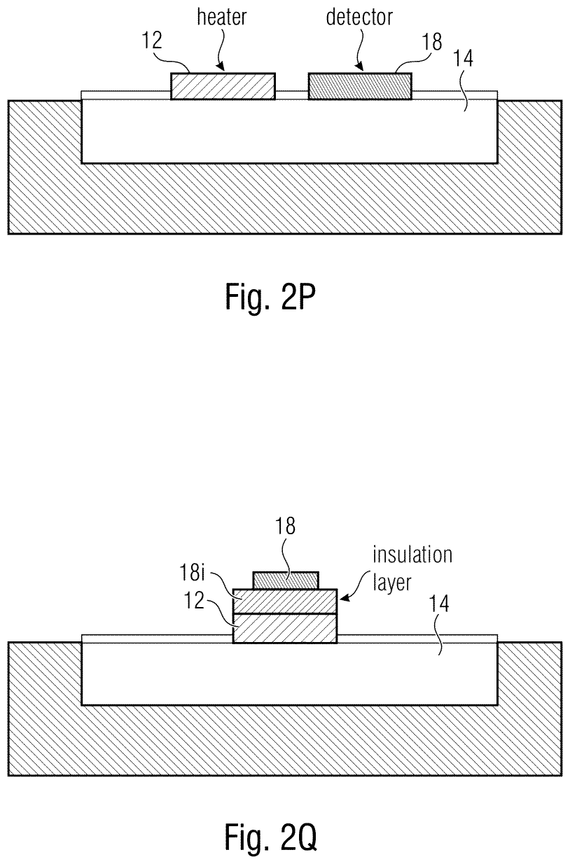

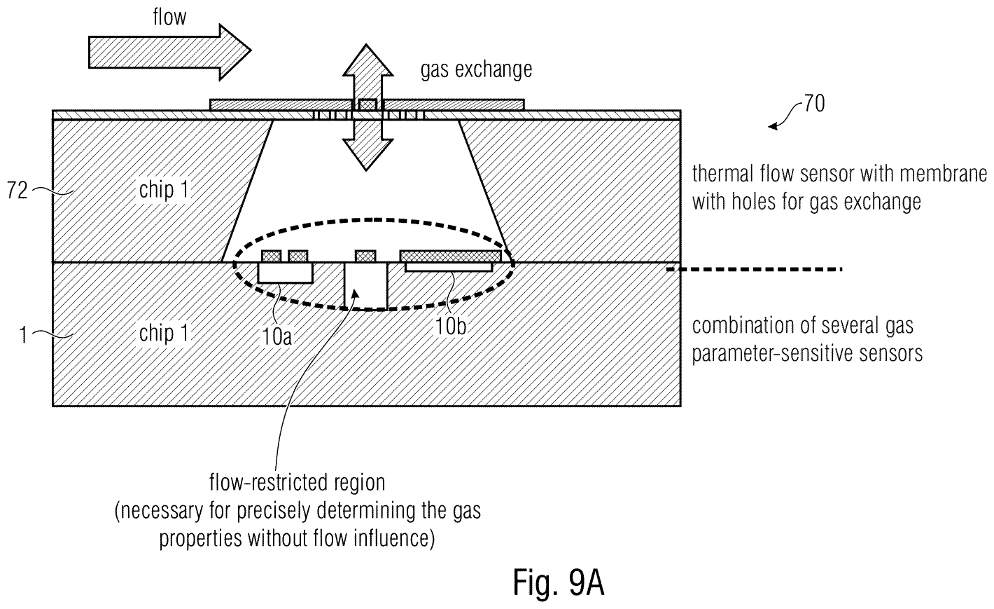

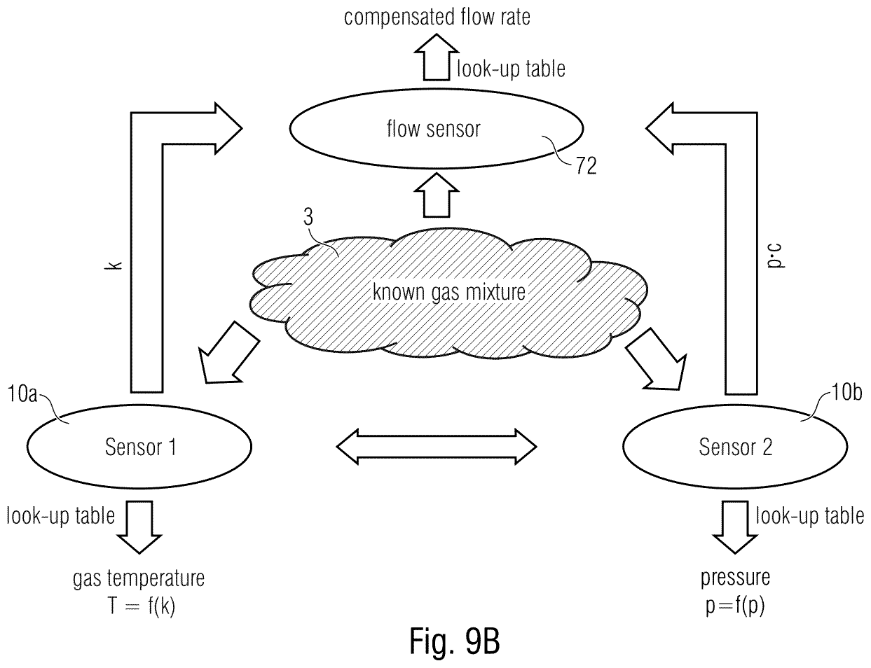

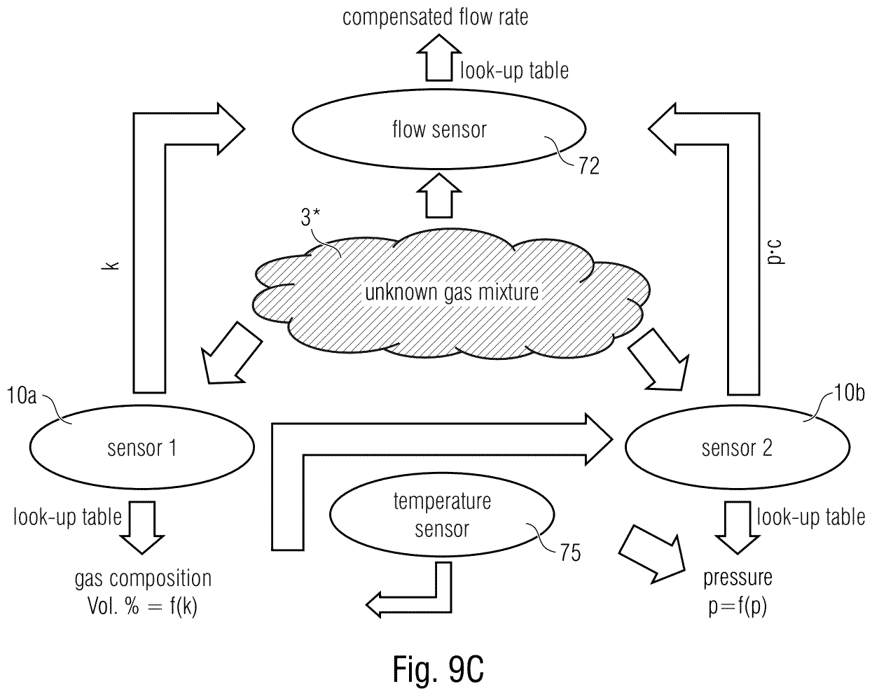

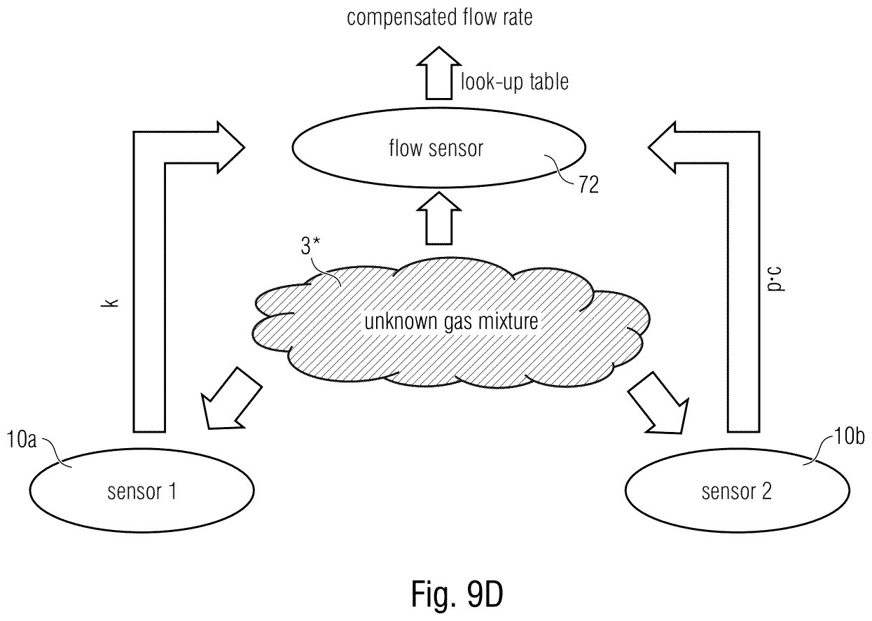

In the above embodiments, it has been assumed, for example, that the heater is excited periodically by means of a square wave signal and a sine signal, wherein the responsiveness of the heater, that is the oscillation behaviour or thermal oscillation behaviour of the heater, can be monitored by only a few thermal elements or changes in resistance. The result of modelling, with an excitation of, for example, 1 kHz, is: amplitude (and phase) of the heater exhibits a dependence on the gas pressure with a (large) gas volume (d=50 μm, b=20 μm) and is insensitive to changes in temperature. The amplitude of the heater exhibits a dependence on the gas temperature with a (small) gas volume (d=5 μm, b=5 μm) but is insensitive to changes in pressure. In this example, too, it has shown that a combination of two or more sensor cells with different dimensioning (d, b, L), advantageously on a chip, is of advantage and that, apart from determining the volume heat capacity and heat conductivity, it also allows providing wide-range sensors for different measuring quantities of temperature and pressure. In accordance with embodiments, a gas-independent wide-range pressure sensor (a few mbar to a few bar) can be provided without any mechanical components (diaphragm). Of course, using this embodiment, gas properties can also be determined (determining heat conductivity and volume heat capacity). In the next step, this allows determining the so-called temperature conductivity or product from density and heat conductivity. Remark: the temperature conductivity is defined as heat conductivity/(density*specific heat capacity), i.e. a=k/(ρ*c). These quantities can advantageously be used for precise on-chip signal compensation in flow sensors or pressure sensors, as will be discussed below referring to FIG. 9. It is also to be pointed out here that, for providing differently dimensioned sensors, the geometry of the heater may also be varied. Meandering shapes, honeycomb-shaped heating structures, heat mirrors, as discussed in connection with FIG. 2, are conceivable.

In accordance with embodiments, the sensor comprises at least one isolated heating element with a surrounding gas volume which is heated periodically and the temperature response of which is determined. In accordance with embodiments, sensors are read out either equally or independently of one another by means of temperature-dependent resistors and/or thermal elements
Variation 1: At least one sensor is scanned at two fixed frequencies or over two frequency ranges, where the thermal sensor has a sufficiently high difference in sensitivity to heat conductivity and volume heat capacity
Variation 2: Two or more sensors (sensor arrays) are configured by geometrical parameter variation (length, width, layer thickness, shape, height of cavity) and/or different material properties such that thermal coupling to the heat sink is different and combined so that it varies sufficiently in the sensitivity to heat conductivity and volume heat capacity during operation in one or more selected frequency ranges or fixed frequencies
In accordance with embodiments, high sensitivity to heat conductivity is achieved for excitations smaller than the cutoff frequency, excitations above the cutoff frequency are of advantage for high sensitivity to volume heat capacity.
Gas properties can be derived using the signal amplitude and/or phase offset
Measured gas properties (k and cv) are used either for direct signal compensation in thermal flow sensors and/or for determining gas composition and pressure

In accordance with embodiments, an arrangement with micro-technological manufacturing methods can be produced to be process-compatible to further (thermal) sensors and thus offers a high integration density for multi-parameter applications (like gas composition and flow rate, for example). Due to the small dead volume, the arrangement may additionally be operated to be highly dynamic. In accordance with embodiments, isolated heating structures surrounded by gas are realized by sacrificial layer technology (surface micromechanics) or bulk micromechanics (dry etching, . . . ). The heating elements provided in this way can be heated periodically by Joule heating. At the same time, the temperature response of the heater is monitored. This arrangement allows strongly miniaturizing the sensor structure. The properties of the gas influence the resulting temperature response of the heating element (amplitude, phase shift). Due to the small space requirements, several of these sensors can easily be integrated with thermal flow sensors on the wafer level. Additionally, only thermal conversion principles are employed. This combination renders the system unique.

In accordance with embodiments, the sensors are sufficiently insensitive and can be operated in the same frequency range, for example if the resulting cutoff frequency differs at least by the factor of 10 due to geometrical parameter variation (length, width, layer thickness, shape, height of the cavity) and/or different material properties.

Examples of decreasing the cutoff frequency
increasing the length of the heater
increasing the height of the cavity.

In accordance with further embodiments, equal sensors are sufficiently insensitive, for example, if they are operated in a first frequency range which is lower by about a factor of 4 than the cutoff frequency, and operated in a second frequency range which is higher by about a factor of 4 than the cutoff frequency of the sensor system.

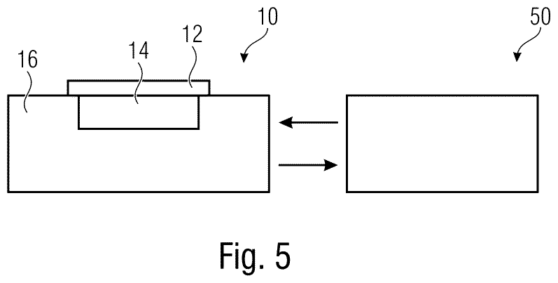

Before details of applications of the sensor arrangement discussed will be explained, a comparison example is to be pointed out here. By specifically varying the excitation or excitation frequency, certain sensor geometries become selective for measuring quantities and insensitive to certain cross influences. This applies to different sensor geometries, but also equal sensor geometries. Consequently, a comparison example provides a sensor system comprising a sensor cell, and evaluation as is shown referring to FIG. 5.

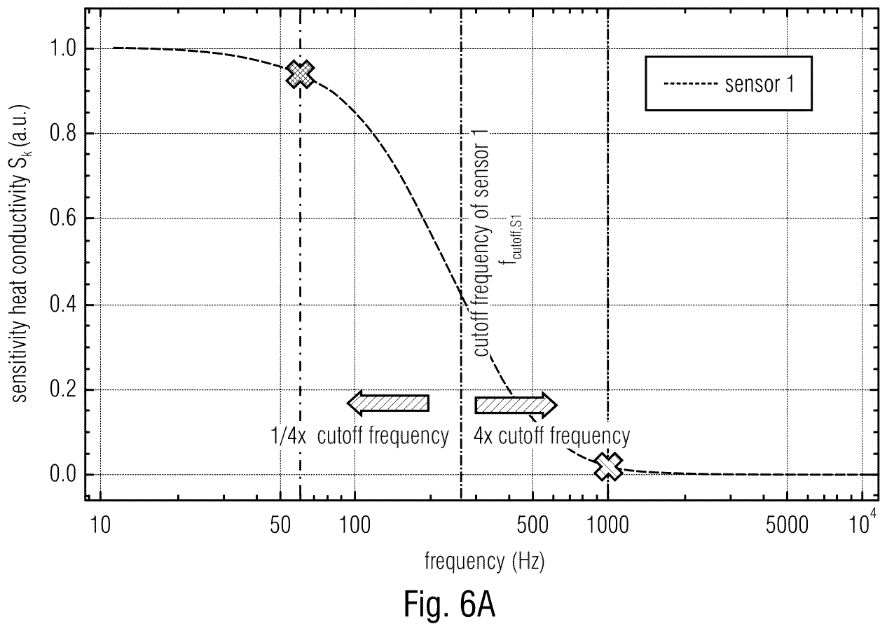

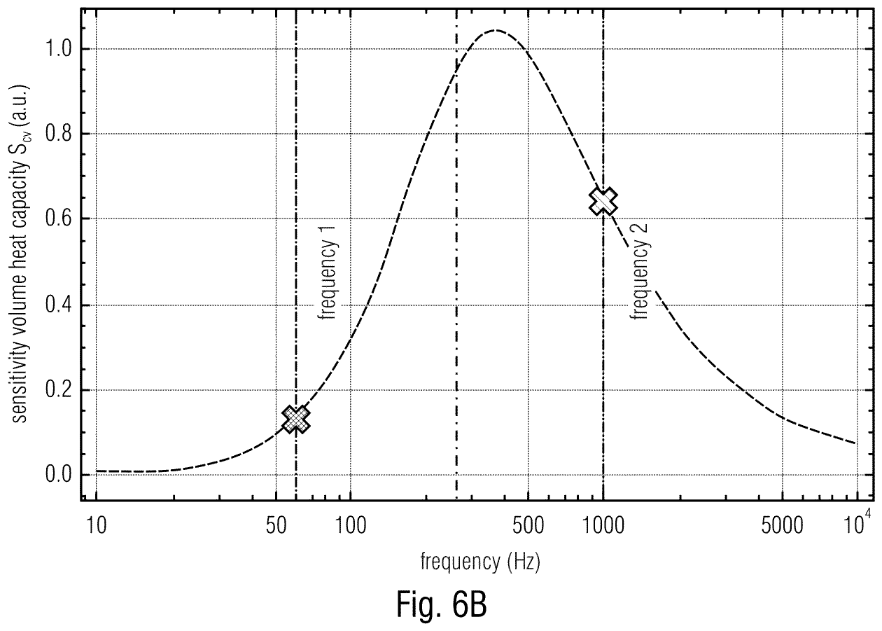

FIG. 5 shows a sensor cell 10 comprising a heater 12, a cavity 14 and a substrate 16, in connection with evaluation 50. The evaluation 50 serves for driving the sensor cell 10 and is configured to drive the sensor cell 10 with at least two different excitation variations, like by means of two different excitation frequencies, for example. For example, the sensor which has a cutoff frequency for certain environmental conditions can be excited by a frequency which is significantly below the cutoff frequency, for example at half the cutoff frequency or a fourth of the cutoff frequency (first measurement) and, for a second measurement, by an excitation frequency significantly above the cutoff frequency, for example two or three times the cutoff frequency. This means that, generally, the first and second measurement which take place at different points in time, are different in that different excitation frequencies are used, advantageously an excitation frequency of smaller than ½ or smaller than ¼ of the cutoff frequency and/or an excitation frequency greater than three times the cutoff frequency. Thus, the sensor cell 10 can be operated at different operating points. As can be seen from FIGS. 6a and 6b, operation at different operating points allows different sensitivities to result for heat conductivity and volume heat capacity. Consequently, the evaluation 50 is configured to determine the heat conductivity by means of the first measurement (operating point smaller than cutoff frequency) and to determine the volume heat capacity by means of the second measurement (operating point greater than cutoff frequency). Two exemplarily selected operating points or frequencies for the two measurements are illustrated in the diagrams of FIGS. 6a and 6b. This mode of operation is of advantage since the volume heat capacity and the heat conductivity can be determined independently of each other by using only a single sensor. The advantage in the variation of FIG. 3 is that the measurements take place simultaneously, whereas in FIG. 5 the measurements take place serially, that is at different points in time.

In accordance with further embodiments, instead of a variation of the excitation frequencies with two fixed frequencies, the sensor 10 can also be excited using a varying signal, like Dirac signal, for example, and then evaluation can take place at different frequencies where the corresponding sensitivities to heat conductivity and volume heat capacity form.

With regard to excitation, it is also to be mentioned that, for example, alternatingly hopping between two frequencies is possible in order to achieve high sensitivity to heat conductivity and volume heat capacity (for example pure sine signal or using harmonics). The at least two different excitations are used for one, two or more sensors (depending on the setup from FIG. 3 or FIG. 5). The result is a modulated periodic excitation with both evaluation frequencies for heat conductivity and volume heat capacity. Potential periodic signal shapes, apart from a sine-shaped excitation, are square wave signals or saw tooth signals.

Different sensor cells will be discussed below referring to FIGS. 2a-o, which all can be employed in the examples mentioned above (embodiments or comparison examples).

FIG. 2a shows the known sensor 10 from FIGS. 1a and 1b having the heater 12 above the cavity 14. In FIG. 2b, a meandering heater 12′ above the cavity 14 is shown, wherein embodiments show that different dimensioning is achieved by different geometry variations of the heater 12′ since the heater 12′ is significantly longer than the heater 12. Both heaters 12 and 12′ are self-supporting structures or self-supporting bridge structures located above the cavity 14.

FIG. 2c also shows a self-supporting bridge structure, but with feed lines having an increased cross-section. This means that a temperature spot of the heater 12″ forms in the center. A similar temperature spot also forms in the heater 12′″ from FIG. 2d since the meander shape is arranged in particular in the center of the cavity. Here, the cavity 14′ is increased relative to the cavity 14 from FIG. 2b. All the previous variations of FIGS. 2a, 2b, 2c and 2d have in common that the cavity has a basically rectangular shape. However, this is not absolutely necessary as is shown, for example, in FIG. 2e.

FIG. 2e shows a sensor cell comprising a round cavity 14″ and a spiral-shaped heater 12″″, which has a two-dimensional appearance.

As mentioned before, the heaters comprise either the type of a self-supporting bridge structure, as is seen in FIG. 2a, FIG. 2c or FIG. 2d, for example. The heater exemplarily includes a conductive material which emits a corresponding Joule energy when a current flows through the same. The conductive material, like metal, for example, forms the self-supporting structure in this case. In accordance with further embodiments, it would also be conceivable for additional supporting structures to be provided, for example, by a membrane or perforated membrane. In accordance with embodiments, the self-supporting structure can be clamped on one side or two sides or, generally, several sides. A structure clamped on one side may also be referred to as a heating rib.

In accordance with embodiments, it would also be conceivable for the heating rib or, generally, the self-supporting structure to be perforated, as is shown in FIG. 2g in the structure 12″″. An increase in the perforated structure 12″″ is illustrated in FIG. 2f. As can be recognized, hexagonal openings are provided here.

In accordance with further embodiments, two heaters 12a and 12b may be arranged above a cavity 14, as can be recognized in FIG. 2h. The heaters may be equal or different. The heaters 12a and 12b illustrated here are parallel to each other and arranged at an equal spaced-apart height above the cavity 14 or heat sink at the bottom of the cavity 14. In accordance with further embodiments, it would also be conceivable for the two heaters 12a and 12b to cross above the cavity 14 so that the two heaters 12a and 12b are arranged at different heights.

In accordance with a further variation, a separate cavity 14a and 14b may be provided for each heater 12a and 12b, as is illustrated in FIG. 2j.

In the above embodiments, it was assumed that the cavity 14 or 14a or 14b or, more precisely, the bottom of the cavity serves as a heat sink. This means that the distance is decisive for the oscillation behavior so that the individual sensor cells can be dimensioned differently using this distance. In accordance with further embodiments, it would also be conceivable for an alternative or additional heat sink to be introduced apart from the heater, as is shown in FIG. 2k.

Apart from the heater 12 arranged above the cavity 14, a further heat sink, for example made of metal, is provided, which here is provided with the reference numeral 13. Two heat sinks may also be formed by two substrates 16a and 16b enclosing the heater 12a. A cavity is formed between the two substrates 16a and 16b, where the heater 12 is positioned. Using a plurality of heat sinks 16a, 16c and 16d is shown in FIG. 2m. In this embodiment, a spacer layer 17 is applied on a substrate, which layer 17 comprises a recess below a heater 12 so that a cavity is formed below the heater 12. Laterally to the heater 12, a heat sink 16c1 and 16c2 is provided in the same level of the heater 12.

FIG. 2n shows a further variation. Several heaters 12* are applied here on the substrate surface of the substrate 16 as parallel structures/heating ribs spaced apart from a substrate 16. The heater of the substrate 12* is implemented as a heating rib having a foot point which is significantly widened relative to the heating rib. This is due to, in particular, manufacturing-technological factors. A further heater manufactured and implemented in a similar way is shown in FIG. 20. Here, the heating rib is again provided with the reference numeral 12*. The variations of FIGS. 2n and 20 are so-called surface micromechanics.

In summary, it can be stated that most different implementations can be used, like honeycomb structures, membrane (with/without holes), additional elements for active heat transmission to the measuring gas (like aluminum), meandering arrangements etc. The potential arrangement of an optional detector will be discussed below.

FIG. 2p shows the heater 12 in combination with the detector 18. The two elements are arranged next to each other in the same level, that is spaced apart equally, above the cavity 14.

FIG. 2q shows the heater 12 on which the detector 18 is arranged to be separated by means of an insulation layer. The insulation layer is provided with the reference numeral 18i. It is of advantage here that excitation and detection take place close to each other, wherein nevertheless excitation and detection are separate. The following detection variations exist, for example, in accordance with embodiments:
resistance detector is stacked above the heater and separated by insulation layer
resistance detector is arranged next to the heater (parallel, surrounding the heater, . . . )
thermal elements may be used in analogy to resistance detectors.

Alternatively, the heater itself can be used as detector, for example by evaluating an electrical response signal. This means that, in accordance with further embodiments, excitation and detection may be performed by the same element (Joule heating of the heater and resistive evaluation of the temperature signal). This variation is not illustrated here.

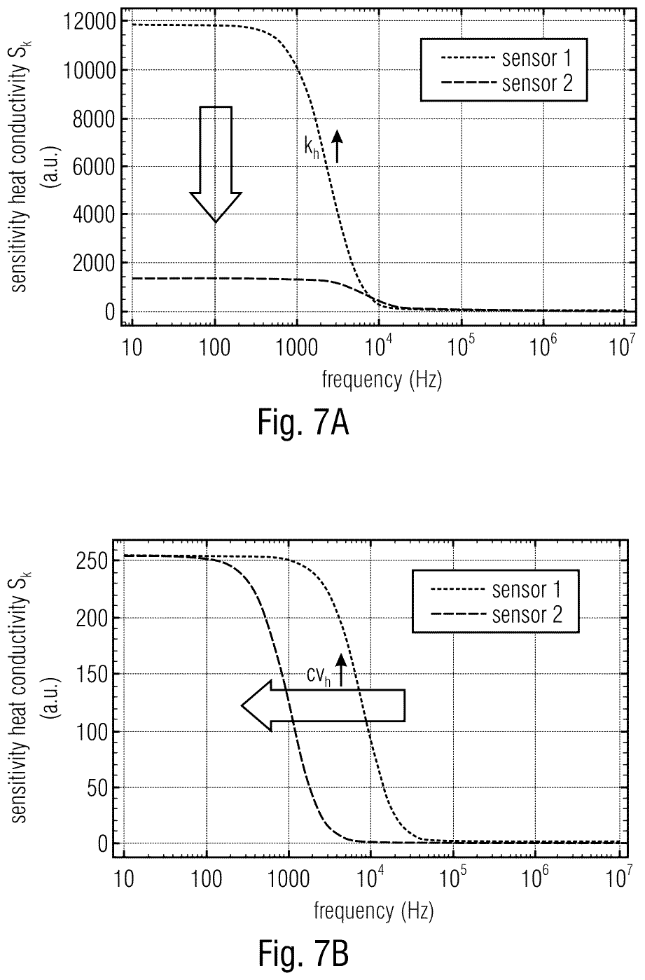

In FIG. 7, ways of changing the frequency-dependent sensitivity Sₖ using the material properties of the heating structure are shown.

Referring to FIG. 7a, which shows the sensitivity of kh over frequency and FIG. 7b, which shows the sensitivity of cvₕ over frequency for two different sensors each, the implementation of one or two sensors in an implementation in accordance with FIG. 3 or the implementation in accordance with FIG. 5 is discussed.

The effect of the heat conductivity of the sensor signal on the frequency-dependent sensitivity Sₖ is shown in FIG. 7a. The two sensors are of equal setup, but the heating structure of sensor 1 has lower a heat conductivity kₕ than sensor 2. The effect of the heat conductivity of the sensor signal on the frequency-dependent sensitivity Sₖ is shown in FIG. 7b. The two sensors are of equal setup, however, the heating structure of sensor 1 has lower a volume heat capacity cvₕ than sensor 2.

Sensor 1 and measurement 1 are to be sensitive to k, whereas sensor 2 and measurement 2 are to be insensitive to k. Two different solutions can be applied here, that is:
a) Solution for lower frequencies (f<<f_{cutoff} or f→0)
b) Solution for higher frequencies in the range of the cutoff frequency (0.5*f<f_{cutoff}).

The following three optimization ways result for a):
Optimize ratio of the cavities: d₁/d₂>20
Optimize ratio of heat conductivities of the heaters: kₕ₁/kₕ₂<0.05
Optimize ratio of product of layer thickness and width of the heaters: (b₁*h₁)/(b₂*h₂)<0.2 (precondition: equal heat transfer area to gas).

The following way of optimization results for solution b: Optimize ratio of product of volume heat capacity and height of the heater:

$$( c {v}_{h 1} * {h}_{1} ) / ( {cv}_{h 2} * {h}_{2} ) < 0.25$$

It is to be pointed out here that the ways of optimization as mentioned above are each to be understood as specific embodiments so that further variations of optimization are conceivable in accordance with further embodiments.

In accordance with embodiments, a geometry adjustment to the gases may take place. The higher k_{gas}, the greater the cavity. Doubling k_{gas} results in quadruplicating d. The smaller k_{gas} and the higher cv_{gas}, the smaller can the frequency be selected.

Starting from the requirements that a sufficient sensitivity to cv is to be possible by means of sensor 1 or measurement 1, and that a sufficient insensitivity to cv is to be obtained by means of sensor 2 or measurement 2, the following solution can be selected for higher frequencies in the range of the cutoff frequency.

When combining the two applications while considering the teaching which can be recognized from FIGS. 7a and 7b, in accordance with embodiments, it is to be stated that the heat conductivity is advantageously evaluated below the cutoff frequency, whereas volume heat capacity is evaluated above the cutoff frequency.

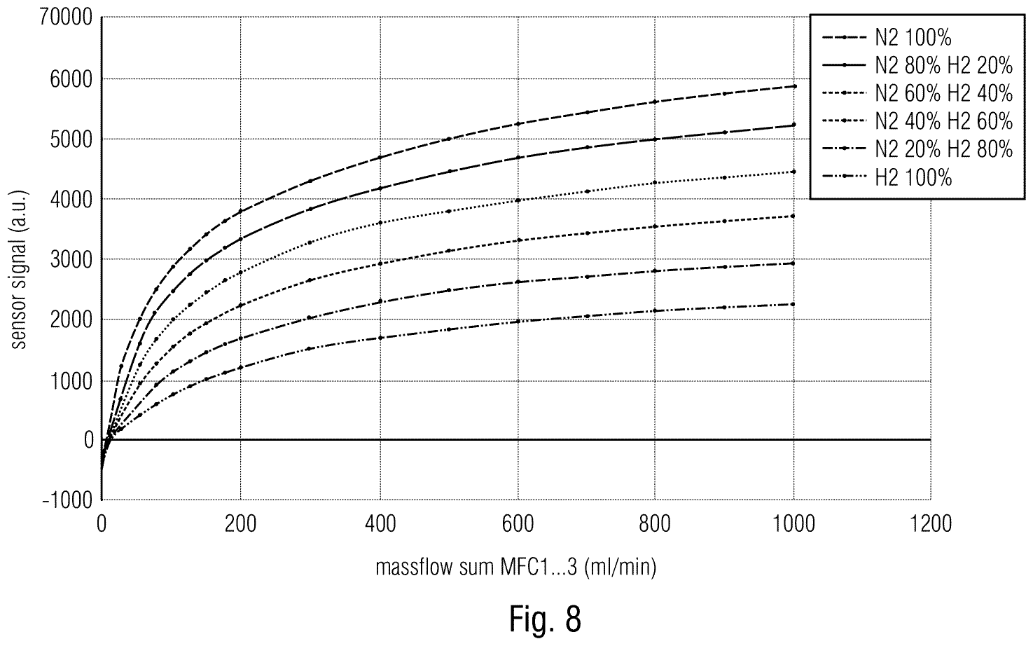

As mentioned already, the gas composition has an effect on all the measurements and, thus, on the output signal in thermal flow sensors, as can be seen from FIG. 8.

FIG. 8 shows a sensor signal as a function of a flow rate measured for different gas compositions. The result is a multitude of characteristic curves. This reveals the necessity for the relevant gas parameters to be advantageously established in direct proximity to the thermal flow sensor in order to determine the characteristic curve in flow sensors. The gas composition can easily and effectively be established using the variations from FIG. 3 or 5, while considering the above teaching.

These micro-technological sensors from FIGS. 3 and 5 can, in accordance with embodiments, be used either for signal compensation in thermal flow sensors, with changing gas media and operating parameters (pressure, temperature), but also offer a way for being used as individual sensors for determining the volume heat capacity, heat conductivity, temperature and pressure.

The result is the application of an inline-capable flow sensor offering a way for signal compensation. FIG. 9a shows a flow sensor 70 with the actual flow sensor 72 in combination with a sensor arrangement 1 comprising the two sensor chips 10a and 10b. The sensor 1 has several gas parameter-sensitive sensors and is located in a cavity of the chip 72, that is in a flow-restricted area. A thermal flow sensor having a membrane with holes for gas exchange is provided on the surface of the sensor 70.

The functionality is illustrated schematically in FIG. 9b. FIG. 9b shows the three sensors 10a, 10b and 72. k of a known gas mixture 3 is determined by means of the sensor 10a. In addition, ρ*c is determined for the same gas mixture 3 by the sensor 10. These two parameters determined can be transferred for compensation to an evaluation device of the flow sensor 72, which determines a flow rate of the gas mixture 3. Compensation may, for example, take place by means of a lookup table so that a compensated flow rate is determined.

For a known gas mixture 3 (heat conductivity and volume heat capacity at reference temperature and reference pressure are known), the following method may apply:
Evaluation of the output signals (amplitude of temperature response) by sensor 10a, which is proportional to the heat conductivity. The heat conductivity depends on the temperature and serves for determining the mean gas temperature.
Obtaining the output signal from sensor 10a is used for compensating the output signals of sensor signals 10b (amplitude). The output signal of sensor 10b depends on the volume heat capacity. The density can be determined by means of compensation, which serves for determining the pressure.

In accordance with further embodiments, the gas temperature T=f(k_{gas}) can be determined based on the sensor values of sensor 10a, and the pressure p=f(cv_{gas}) by means of the sensor signal of sensor 10b. In both variations, a lookup table can be used. It is to be pointed out here that it is not absolutely necessary for the gas mixture to be known (cf. FIG. 9c).

For example, using a further sensor 75, that is a temperature sensor, the gas composition can also be determined based on the sensor signal of sensor 10a, based on an unknown mixture 3*. Knowing the gas composition vol. %=f(k_{gas}), using the sensor signal of sensor 10b, a corrected flow rate can be determined, as discussed above (using the flow sensor 72).

As is shown in FIG. 9d, the temperature sensor is not absolutely necessary since determining the two values k and pc using the sensors 10a and 10b, based on the unknown gas mixture 3*, is sufficient to compensate the flow rate of the flow sensor 72. It is a peculiarity here that temperature, pressure and gas composition are not determined directly, wherein these are not absolutely necessary for absolute signal compensation.

The above discussion has shown that a further embodiment relates to a flow sensor having a sensor arrangement of FIG. 3. Here, the sensor 10a, for example, exhibits high sensitivity to heat conductivity and sensor 10b exhibits high sensitivity to volume heat capacity. Alternatively, the sensor with the evaluation from FIG. 5 may also be used since the same parameters can be determined correspondingly during operation.

A further embodiment relates to a pressure sensor which determines a compensated pressure, knowing the parameters k and ρ*c.

It is to be pointed out here that the heat conductivity is advantageously evaluated below the cutoff frequency, as can be recognized from FIGS. 7a and 7b.

A further embodiment relates to a method for operating the sensor arrangement. In accordance with embodiments, the operating point can be determined here. A method for determining the optimum sensor configuration may be implemented as follows:

In order to configure the sensor/sensor arrangement, for example for a universal measuring range, in accordance with embodiments, the operating points can be looked for using a self-adjusting method:
Sensor geometry: creating and varying the structure for operation at equal frequency
Sensor operation: frequency scan for determining the gas-dependent operating point (also dependent on pressure/temperature)→looking for the local maximum for the highest difference in sensitivity between sensor groups 1 and 2.

In order to determine the optimum operating points of the highest sensitivity to the measurement quantity (heat conductivity or volume heat capacity) for a sensor arrangement within the multi-dimensional parameter field, changes in the heat conductivity (like temperature variations, gas composition) and/or volume heat capacity (like pressure, gas composition) have to be provoked: this may be done on a calibration measuring station for a configured sensor arrangement. However, even in a non-optimum operating point, the measuring quantities can be determined, that is the sensor arrangement can also be used in a non-calibrated state.

In accordance with embodiments, the sensor chip, like the sensor chip of FIG. 5 or sensor chip of FIG. 3, comprises evaluation. Preferably, the one or more sensors are manufactured on a common chip. Depending on the compatibility with the manufacturing processes with thermal flow sensors, the flow sensor can be manufactured on the same chip. In accordance with a further embodiment, the ASIC can also be manufactured on the same chip. The ASIC or, in general, evaluation electronics is configured to easily process the combination of signals of several sensors for a dynamic on-chip signal compensation of thermal flow sensor. Thus, a highly miniaturized sensor of high dynamics and potential for monolithic integration is provided.

In accordance with embodiments, one or more sensors and one and/or more sensors in combination with evaluation are integrated monolithically. Here, either only the sensor for determining the gas parameters is provided, or the sensor may be extended by pressure sensors or flow sensors.

An embodiment provides a sensor arrangement comprising at least two highly miniaturized sensors with thermal operating principles for determining an individual gas property (volume heat capacity cv (product of density and specific heat capacity) or heat conductivity k). These thermal sensors are configured such that at least one component exhibits high sensitivity to one gas property, whereas at least one further component exhibits high sensitivity to another gas property. The challenge is producing a structure, sensitive to a gas property, while at the same time minimizing cross-sensitivities. As mentioned already, the gas properties are not only dependent on the composition, but also temperature and pressure. However, this influence varies strongly and can be used to employ several combined gas property sensors indirectly for determining pressure and temperature. Small changes in pressure (Δp<10 bar) in a first approximation only result in a change in the gas density. Variations in temperature (ΔT<50 K), however, in a first approximation, have an effect on density and heat conductivity. The specific heat capacity, however, remains almost uninfluenced by changes in pressure and temperature.

Description of variables used above:
dimensions of the heater: L, b, h
height of the cavity: d
material properties of the heater: cvₕ, kₕ
gas properties k, cv or, for improved unambiguity, k_{gas}, cv_{gas}
sensitivities to gas properties Sₖ, S_{cv}
width of the effective heat transfer area to gas b_{gas}
cutoff frequencies f_{cutoff} or f_{cutoff,S1}

Although some aspects have been described in the context of an apparatus, it is understood that these aspects also represent a description of the corresponding method so that a block or a structural component of an apparatus is also to be understood to be a corresponding method step or feature of a method step. In analogy, aspects described in the context of or as a method step also represent a description of a corresponding block or detail or feature of a corresponding apparatus. Some or all of the method steps may be performed by a hardware apparatus (or using a hardware apparatus), such as a microprocessor, a programmable computer or an electronic circuit. In some embodiments, some or several of the most important method steps may be performed by such an apparatus.

Depending on specific implementation requirements, embodiments of the invention may be implemented in hardware or in software. Implementation may be effected while using a digital storage medium, for example a floppy disc, DVD, Blu-ray disc, CD, ROM, PROM, EPROM, EEPROM or FLASH memory, a hard disc or any other magnetic or optical memory which has electronically readable control signals stored thereon which may cooperate, or cooperate, with a programmable computer system such that the respective method is performed. This is why the digital storage medium may be computer-readable.

Some embodiments in accordance with the invention thus comprise a data carrier which comprises electronically readable control signals which are capable of cooperating with a programmable computer system such that any of the methods described herein is performed.

Generally, embodiments of the present invention may be implemented as a computer program product having a program code, the program code being effective to perform any of the methods when the computer program product runs on a computer.

The program code may also be stored on a machine-readable carrier, for example.

Other embodiments include the computer program for performing any of the methods described therein, the computer program being stored on a machine-readable carrier. In other words, an embodiment of the inventive method thus is a computer program which has program code for performing any of the methods described herein, when the computer program runs on a computer.

A further embodiment of the inventive methods thus is a data carrier (or a digital storage medium or a computer-readable medium) on which the computer program for performing any of the methods described herein is recorded.

A further embodiment of the inventive method thus is a data stream or a sequence of signals representing the computer program for performing any of the methods described herein. The data stream or the sequence of signals may be configured, for example, to be transferred via a data communication link, for example via the Internet.

A further embodiment includes processing means, for example a computer or a programmable logic device, configured or adapted to perform any of the methods described herein.

A further embodiment includes a computer on which the computer program for performing any of the methods described herein is installed.

A further embodiment in accordance with the invention comprises an apparatus or a system configured to transmit a computer program for performing at least one of the methods described herein to a receiver. The transmission may, for example, be electronic or optical. The receiver may, for example, be a computer, mobile device, memory device or a similar apparatus. The apparatus or system may, for example, comprise a file server for transmitting the computer program to the receiver.

In some embodiments, a programmable logic device (for example field-programmable gate array, FPGA) may be used to perform some or all of the functionalities of the methods described herein. In some embodiments, a field-programmable gate array may cooperate with a microprocessor so as to perform any of the methods described herein. Alternatively, a microcontroller (like PSoC, Programmable System on Chip) and/or lock-in technology may be used. In general, in some embodiments, the methods are performed by any hardware apparatus, which may be universally employable hardware, like a computer processor (CPU), or hardware specific for the method, like an ASIC, for example.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. A sensor arrangement comprising:
a first sensor cell which can be excited thermally by means of a first heater;
a second sensor cell which can be excited thermally by means of a second heater; and
an evaluation;
wherein the first sensor cell and the second sensor cell are sensor cells of the same kind and wherein the first sensor cell and the second sensor cell are dimensioned and/or configured differently;
wherein the first sensor cell and the second sensor cell are configured to form a respective oscillation behavior, in particular oscillation behavior of the respective first or second heater, in dependence on a gas property of a gas surrounding the first and second sensor cell, in particular heat conductivity and/or volume heat capacity and/or temperature and/or pressure,
wherein the evaluation is configured to evaluate the respective oscillation behavior of the first sensor cell and the second sensor cell together in order to determine the heat conductivity and volume heat capacity, wherein the heat conductivity is determined based on the oscillation behavior of the first sensor cell and wherein the volume heat capacity is determined based on the oscillation behavior of the second sensor cell.

2. The sensor arrangement in accordance with claim 1, wherein the first sensor cell and/or the second sensor cell comprise a cavity comprising a heater, or a heat sink comprising a spaced-apart heater, or a heating rib spaced apart from a heat sink; and/or
wherein the heater is formed by a heating rib or a self-supporting structure or self-supporting bridge structure; and/or
wherein the heater or heating rib is configured to oscillate thermally and thus form the oscillation behavior.

3. The sensor arrangement in accordance with claim 1, wherein the first sensor cell and/or the second sensor cell comprise a detector configured to detect the oscillation behavior.

4. The sensor arrangement in accordance with claim 1, wherein the first and second sensor cells are dimensioned differently if they differ relative to one or more parameters from the following group of:
volume of the sensor cell,
width of the heater or heating rib,
thickness of the heater or heating rib,
area of the heater or heating rib,
distance from the heater or heating rib to a heat sink,
height of the heater or heating rib above the cavity,
width of the cavity,
height of the cavity,
area of the cavity,
volume of the cavity,
length of the heater,
geometry of the heater or heating rib,
material of the heater or heating rib.

5. The sensor arrangement in accordance with claim 1, wherein the first and second sensor cells are configured differently if a respective cutoff frequency of the first and second senor cells differs by at least a factor of 3, at least a factor of 5 and/or at least a factor of 10.

6. The sensor arrangement in accordance with claim 1 wherein the sensitivity to volume heat capacity of the second sensor cell is higher by at least a factor of 3, at least a factor of 4 or at least a factor of 5 than the sensitivity of the first sensor cell to volume heat capacity; and/or
wherein the sensitivity to heat conductivity of the first sensor cell is higher by at least a factor of 1.1 or at least a factor of 1.2 than the sensitivity of the second sensor cell to heat conductivity.

7. The sensor arrangement in accordance with claim 1, wherein the evaluation is configured to periodically excite the first and/or second sensor cell.

8. The sensor arrangement in accordance with claim 7, wherein the first and/or second sensor cell is excited by an equal frequency and/or an equal frequency at the same time.

9. The sensor arrangement in accordance with claim 7, wherein the first and second sensor cells are excited by different frequencies and/or different frequencies at the same time; and/or
wherein the excitation takes place at an excitation frequency and wherein the excitation frequency or evaluation frequency of the first sensor cell is below the cutoff frequency or at least below ½ of the cutoff frequency or at least below ¼ of the cutoff frequency; and/or
wherein the second sensor cell is excited by an excitation frequency and wherein the excitation frequency or evaluation frequency of the second sensor cell is above a cutoff frequency or at least above three times the cutoff frequency.

10. The sensor arrangement in accordance with claim 1, wherein the evaluation determines the oscillation behavior of the first and second sensor cells using the dynamic temperature response and/or using the amplitude and/or using the frequency and/or using the phase; and/or
wherein the evaluation is configured to determine the respective oscillation behavior using a model which describes the excitation at the cutoff frequency to be proportionate to the temperature conductivity of the gas, wherein the temperature conductivity is defined to be a division of the heat conductivity divided by the volume heat capacity.

11. The sensor arrangement in accordance with claim 1, wherein the first sensor cell and/or the second sensor cell are integrated on a chip or monolithically on a chip.

12. The sensor arrangement in accordance with claim 1, wherein the evaluation is implemented as an ASIC, wherein the ASIC is integrated in a chip or monolithic chip, which accommodates the first and second sensor cells.

13. A sensor arrangement comprising:
a first sensor cell which can be excited thermally by means of a first heater; and
a second sensor cell which can be excited thermally by means of a second heater;
wherein the first sensor cell and the second sensor cell are sensors of the same kind and wherein the first sensor cell and the second sensor cell are dimensioned and/or configured differently;
wherein the first sensor cell and the second sensor cell are configured to change a respective oscillation behavior in dependence on a gas property of a gas surrounding the first and second sensor cells, in particular heat conductivity and/or volume heat capacity and/or temperature and/or pressure,
wherein the respective oscillation behavior of the first sensor cell and the second sensor cell can be evaluated together in order to determine the heat conductivity and volume heat capacity, wherein the heat conductivity is determined based on the oscillation behavior of the first sensor cell, and wherein the volume heat capacity is determined based on the oscillation behavior of the second sensor cell.

14. A flow sensor comprising a sensor arrangement in accordance with claim 1, wherein the flow sensor is configured to determine a flow while considering the heat conductivity and volume heat capacity determined.

15. A flow sensor comprising a sensor arrangement in accordance with claim 13, wherein the flow sensor is configured to determine a flow while considering the heat conductivity and volume heat capacity determined.

16. A pressure sensor comprising a sensor arrangement in accordance with a claim 1, wherein the pressure sensor is configured to determine the pressure while considering the volume heat capacity and the heat conductivity.

17. A pressure sensor comprising a sensor arrangement in accordance with claim 13, wherein the pressure sensor is configured to determine the pressure while considering the volume heat capacity and the heat conductivity.

18. A method for evaluating a sensor arrangement in accordance with claim 1, comprising:
evaluating a respective oscillation behavior of the first and second sensor cells together in order to determine the heat conductivity and volume heat capacity (or determine physical parameters of a first group and physical parameters of a second group), wherein the heat conductivity is determined based on the oscillation behavior of the first sensor cell, and wherein the volume heat capacity is determined based on the oscillation behavior of the second sensor cell.

19. A method for evaluating a sensor arrangement in accordance with claim 13, comprising:
evaluating a respective oscillation behavior of the first and second sensor cells together in order to determine the heat conductivity and volume heat capacity (or determine physical parameters of a first group and physical parameters of a second group), wherein the heat conductivity is determined based on the oscillation behavior of the first sensor cell, and wherein the volume heat capacity is determined based on the oscillation behavior of the second sensor cell.

20. A non-transitory digital storage medium having stored thereon a computer program for performing a method for evaluating a sensor arrangement in accordance with claim 1, comprising: evaluating a respective oscillation behavior of the first and second sensor cells together in order to determine the heat conductivity and volume heat capacity (or determine physical parameters of a first group and physical parameters of a second group), wherein the heat conductivity is determined based on the oscillation behavior of the first sensor cell, and wherein the volume heat capacity is determined based on the oscillation behavior of the second sensor cell, when the computer program is run by a computer or the evaluation.

21. A non-transitory digital storage medium having stored thereon a computer program for performing a method for evaluating a sensor arrangement in accordance with claim 13, comprising: evaluating a respective oscillation behavior of the first and second sensor cells together in order to determine the heat conductivity and volume heat capacity (or determine physical parameters of a first group and physical parameters of a second group), wherein the heat conductivity is determined based on the oscillation behavior of the first sensor cell, and wherein the volume heat capacity is determined based on the oscillation behavior of the second sensor cell, when the computer program is run by a computer or the evaluation.
